(19) United States
(12) Patent Application Publication
(10) Pub. No.: US 2022/0403631 A1
(43) Pub. Date: Dec. 22, 2022

(54) LIQUID RECOVERY SYSTEM, LIQUID SUPPLY SYSTEM, AND PRESSURE REGULATING METHOD

(71) Applicant: NOMURA MICRO SCIENCE CO., LTD., Kanagawa (JP)

(72) Inventor: Katsumi YAMAMOTO, Kanagawa (JP)

(73) Assignee: NOMURA MICRO SCIENCE CO., LTD., Kanagawa (JP)

(21) Appl. No.: 17/839,530

(22) Filed: Jun. 14, 2022

(30) Foreign Application Priority Data
Jun. 16, 2021 (JP) 2021-100415

(51) Int. Cl. E03B 7/07; E03B 11/02; E03B 1/04

(52) U.S. Cl. CPC E03B 7/075; E03B 11/02; E03B 1/048

(57) ABSTRACT

A ultrapure water supply system 10 includes a pure water tank 16 provided vertically below a use point 30, a return pipe 32 through which ultrapure water is returned from the use point 30 to the pure water tank 16, a first pressure regulating valve 40 that is provided at a first position H1 of the return pipe 32 and adjusts a first pressure upstream of the first position H1 and a second pressure regulating valve 42 that is provided at a second position H2 downstream of the first position H1 and vertically below the first position H1 of the return pipe 32 and adjusts a second pressure downstream of the first position H1 and upstream of the second position H2.

### CROSS-REFERENCE TO RELATED APPLICATION

This application claims the benefit of priority of Japanese Patent Application No. 2021-100415 filed on Jun. 16, 2021, the contents of which are incorporated by reference as if fully set forth herein in their entirety.

### BACKGROUND

### Technical Field

The present disclosure relates to a liquid recovery system, a liquid supply system, and a pressure regulating method.

### Related Art

In ultrapure water production systems, a technique of supplying produced ultrapure water to a use point and returning ultrapure water not used at a place for use (hereinafter referred to as a use point) to a pure water tank has been proposed. In Japanese Patent Application Laid-Open (JP-A) No. 2019-162569, a pressure regulating means is provided in a return pipe for returning ultrapure water to a pure water tank and returning pure water from a use point to the tank. Then, based on the flow rate and the return pressure in the return pipe, a pressure regulating means such as a pressure regulating valve is controlled to prevent the pressure at the use point from deviating from a desired pressure.

In general, a pure water production device, an ultrapure water production device, or the like, which is a utility of various production plants, is often installed on a lower floor of the plant. Manufacturing facilities using ultrapure water or the like are often installed on an upper floor of a factory. Therefore, the produced pure water, ultrapure water, or the like is pressurized by a pump and supplied to the use point at the upper floor. Specifically, in recent years, in the case of a semiconductor manufacturing or liquid crystal manufacturing factory, since the scale of the factory itself has been increased, the factory itself often becomes taller, and in this case, the height difference between the pure water production device and the like and the use point is further increased.

In addition, various production facilities are installed at the use point, and it is necessary to supply ultrapure water at an optimum pressure for the facilities. Similarly, pure water, ultrapure water, or the like that is not used at a place for use (use point) is returned to an ultrapure water production device or the like, and a height difference at the case also increases.

As described above, in a case in which the use point is at a position higher than the pure water tank in the ultrapure water production device and the height difference between the use point and the tank position is large, the pressure difference between the upstream side and the downstream side of the pipe is large, and it may be difficult to adjust the pressure. In addition, it has been found that a negative pressure is generated in a pipe connecting a pressure regulating valve or the like installed immediately after the use point and the tank, the pipe is deformed, or the atmosphere enters the pipe from a joint of the pipe such as a flange portion. In addition, in the case of the functional water, air bubbles are generated due to the negative pressure, and there is a possibility that the performance as the functional water is deteriorated, or malfunction or operation failure of the pump due to the air bubbles is caused. In the case of a device that is required to continue to pass water for a long period of time, such as an ultrapure water production device, the possibility of causing the above problem increases due to continuation of passing water.

### SUMMARY

In consideration of the above fact, an object of the disclosure is to provide a technique capable of easily adjusting the pressure at the use point and suppressing mixing of the atmosphere into the liquid flowing into the tank.

A liquid recovery system according to a first aspect includes a tank that is provided vertically below a use point, at which a liquid is used, and that stores the liquid, a pipe that connects the use point and the tank and through which the liquid is returned from the use point to the tank, a first pressure regulating unit that is provided at a first position of the pipe, and that regulates a first pressure upstream of the first position, and a second pressure regulating unit that is provided at a second position downstream of the first position of the pipe and vertically below the first position, and that regulates a second pressure downstream of the first position and upstream of the second position.

In the liquid recovery system of the first aspect, the tank is provided vertically below the use point, and the first pressure regulating unit and the second pressure regulating unit are provided in the pipe through which the liquid is returned from the use point to the tank. The first pressure regulating unit is provided at a first position of the pipe, and regulates the first pressure upstream of the first position. The second pressure regulating unit is provided at a second position downstream of the first position of the pipe and vertically below the first position, and regulates the second pressure downstream of the first position and upstream of the second position.

As described above, by providing the first pressure regulating unit and the second pressure regulating unit, it is possible to control the pressure difference due to the height difference of the pipe in a stepwise manner as compared with a case in which there is one pressure regulating unit. That is, by setting the first position to a position where the pressure regulation of the use point can be easily performed, the pressure of the use point upstream of the first position where the predetermined pressure is required can be easily adjusted.

In addition, by setting the second position at a position below the first position, it is possible to reduce the height difference from the second pressure regulating unit to the tank in the midway of the downstream pipe, and it is possible to suppress the deformation of the pipe due to the action of the negative pressure in the pipe due to the pressure difference caused by the height difference and the inflow of the atmosphere into the pipe.

In the liquid recovery system according to a second aspect, the first position is above a central portion of the pipe in a vertical direction, and the second position is below the central portion.

According to the liquid recovery system of the second aspect, by providing the first pressure regulating unit at a position close to the use point, the pressure at the use point can be easily adjusted to an appropriate pressure, and by providing the second pressure regulating unit at a position close to the tank, the height difference in the pipe from the second position to the tank can be reduced, so that the pressure difference in the pipe due to the height difference is reduced, and the deformation of the pipe due to the action of the negative pressure on the pipe and the inflow of foreign matter into the pipe can be suppressed.

The height difference between the second position and t water level of the tank is preferably 4 m or less.

In the liquid recovery system according to a third aspect, the second position is at a height equal to or lower than a water level of the tank in a vertical direction.

According to the liquid recovery system of the third aspect, since the pressure of the pipe downstream of the second position is equal to or higher than the pressure at the water surface of the tank, it is possible to suppress the deformation of the pipe due to the action of the negative pressure on the pipe and the inflow of foreign matter into the pipe.

In the liquid recovery system according to a fourth aspect, the second position is at a height at which the downstream pressure is positive and constant.

According to the liquid recovery system of the fourth aspect, it is possible to prevent the pressure in the pipe downstream of the second position from becoming a negative pressure, and it is possible to suppress the deformation of the pipe due to the action of the negative pressure on the pipe and the inflow of foreign matter into the pipe.

In the liquid recovery system according to a fifth aspect, the first pressure regulating unit regulates the first pressure so that the first pressure is a predetermined upstream pressure.

According to the liquid recovery system of the fifth aspect, the first pressure can be maintained at a predetermined upstream pressure.

In the liquid recovery system according to a sixth aspect, the second pressure regulating unit regulates the second pressure so that the second pressure is a predetermined intermediate pressure.

According to the liquid recovery system of the sixth aspect, the second pressure can be maintained at a predetermined intermediate pressure.

In the liquid recovery system according to a seventh aspect, the second pressure regulating unit regulates the second pressure so that a difference between the second pressure and an atmospheric pressure is a predetermined value.

According to the liquid recovery system of the seventh aspect, the difference between the second pressure and the atmospheric pressure can be maintained at a predetermined value.

A liquid supply system according to an eighth aspect includes the liquid recovery system according to any one of the first aspect to the seventh aspect, a processing unit that processes the liquid stored in the tank, and a use supply path that supplies the liquid processed by the processing unit to the use point.

According to the liquid supply system of the eighth aspect, it is possible to re-supply the liquid collected from the use point to the use point via the processing unit and circulate the liquid.

A liquid supply system according to a ninth aspect further includes a primary, processing unit that performs primary processing of raw water, and a primary supply path through which a primary processed liquid processed by the primary processing unit is supplied to the tank.

According to the liquid supply system of the ninth aspect, the raw water primarily processed by the primary processing unit and the liquid returned from the use point can be supplied from the tank to the use point via the processing unit.

A pressure regulating method according to a tenth aspect is a pressure regulating method of connecting a use point, at which a liquid is used, and a tank that is provided vertically below the use point and that stores the liquid, and regulating a pressure of a pipe through which the liquid is returned from the use point to the tank, where the pressure regulating method includes adjusting a first pressure upstream of a first position of the pipe to a predetermined upstream pressure, and adjusting a second pressure upstream of a second position, the second position downstream of the first position of the pipe and vertically below the first position to a predetermined intermediate pressure.

In the pressure regulating method of the tenth aspect, as described above, by adjusting the pressure at the first position and the second position, it is possible to control the pressure difference due to the height difference of the pipe in a stepwise manner as compared with a case in which the pressure regulation is performed at one place. That is, by setting the first position to a position where the pressure regulation of the use point can be easily performed, the pressure of the use point upstream of the first position where the predetermined pressure is required can be easily adjusted. In addition, by setting the second position at a position lower than the first position, it is possible to reduce the height difference from the second position to the tank in the midway of the downstream pipe, and it is possible to suppress the deformation of the pipe caused by the action of the negative pressure in the pipe due to the pressure difference caused by the height difference and the inflow of foreign matter into the pipe.

In the present application, it is possible to easily adjust the pressure at the use point and to suppress mixing of the atmosphere into the liquid flowing into the tank.

### BRIEF DESCRIPTION OF THE DRAWINGS

Exemplary embodiments of the present disclosure will be described in detail based on the following figures, wherein:

FIG. 1 is a configuration diagram illustrating an ultrapure water supply system according to a first embodiment,

FIG. 2 is a configuration diagram of the vicinity of a pure water tank of the first embodiment.

FIG. 3 is a block diagram of a control system related to a pressure regulating unit according to the first embodiment.

FIG. 4A is a configuration diagram illustrating a modification of the ultrapure water supply system according to the first embodiment.

FIG. 4B is a configuration diagram illustrating another modification of the ultrapure water supply system according to the first embodiment.

FIG. 5 is a configuration diagram illustrating an ultrapure water supply system according to a second embodiment.

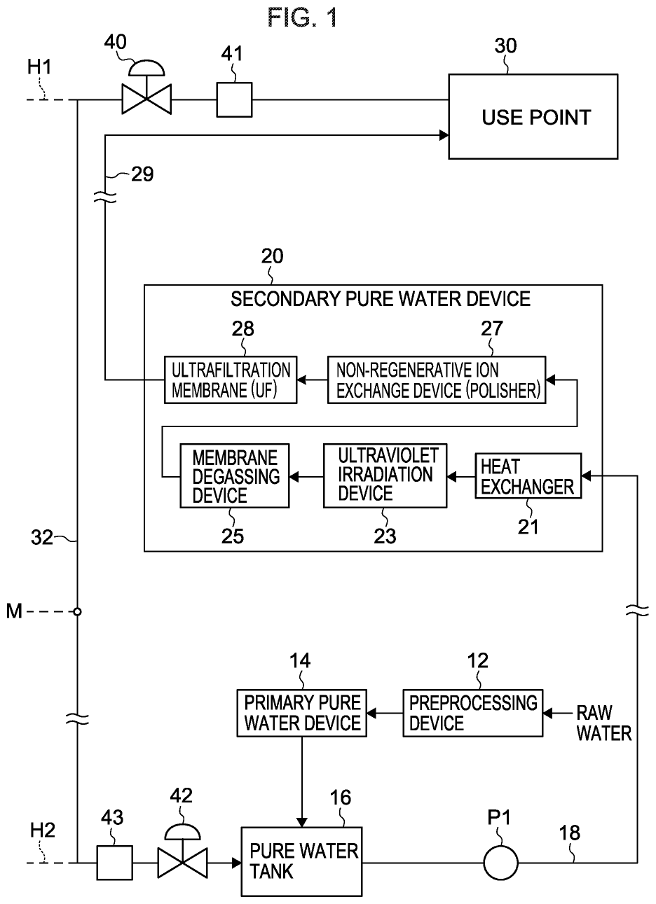

### DETAILED DESCRIPTION

### First Embodiment

Hereinafter, a liquid recovery system, a liquid supply system, and a pressure regulating method according to a first embodiment of the present invention will be described with reference to the drawings. In the present embodiment, an example in which ultrapure water is supplied and recovered as a liquid will be described.

An ultrapure water supply system 10 of the present embodiment includes a preprocessing device 12, a primary pure water device 14, a pure water tank 16, a secondary pure water device 20, and a use point 30. The secondary pure water device 20 further includes a heat exchanger 21, an ultraviolet irradiation device 23, a membrane degassing device 25, a non-regenerative ion exchange device (polisher) 27, and an ultrafiltration membrane (UF) 28.

Raw water is supplied to the preprocessing device 12. The preprocessing device 12 removes turbidity from the supplied raw water by using a flocculation and sedimentation means, a sand filtration means, a membrane filtration means, or the like, and obtains preprocessing water from which some of suspended substances and organic substances is removed. Examples of the raw water include industrial water, tap water, groundwater, river water, and the like.

In the primary pure water device 14, the preprocessing water obtained by the processing in the preprocessing device 12 is further subjected to a cleaning process to remove impurities from the preprocessing water, thereby obtaining primary pure water. Specifically, the primary pure water device include various devices such as a desalting device that removes impurity ions, a reverse osmosis membrane device that removes inorganic ions, organic substances, fine particles, and the like, a vacuum degassing device or a membrane degassing device that removes dissolved gas such as dissolved oxygen, and a regenerative mixed bed desalting device or an electric regenerative desalting device that removes remaining ions.

The primary pure water Obtained by the primary pure water device 14 is supplied to the pure water tank 16. The pure water tank 16 is a container that temporarily stores the primary pure water obtained by the primary pure water device 14. The material, shape, and the like of the pure water tank 16 are not particularly limited as long as there is no component elution from the container, no generation of rust, and the like, and the primary pure water can be stably stored. For example, a materials such as fiber reinforced plastics (FRP), polyethylene, SUS304, SUS316, or Teflon (registered trademark) lining thereof is preferably used. In addition, the upper portion of the pure water tank 16 is preferably purged with pure nitrogen in order to prevent absorption of impurity gases such as carbon dioxide gas and oxygen.

As described later, in a case in which the ultrapure water unused at the use point 30 among the produced ultrapure water is circularly recovered, the unused ultrapure water is mixed with the primary pure water and stored in the pure water tank 16. The mixed water of the primary pure water stored in the pure water tank 16 and the ultrapure water returned from the use point is also hereinafter referred to as “primary pure water”. The water level of the primary pure water stored in the pure water tank 16 from a ground G is defined as H0. The pure water tank 16 is connected to the secondary pure water device 20 via a first delivery pipe 18. The first delivery pipe 18 is provided with a first pump P1, and the primary pure water is delivered from the pure water tank 16 to the secondary pure water device 20 by the first pump P1.

The preprocessing device 12, the primary pure water device 14, and the pure water tank 16 are disposed at relatively low positions in the installation place of the ultrapure water supply system 10, and are disposed, for example, on the first floor or the underground floor of a factory building.

The secondary pure water device 20 is disposed at a position higher than the pure water tank 16 in the vertical direction. The secondary pure water device 20 may be installed at the same position as the pure water tank 16. The heat exchanger 21 of the secondary pure water device 20 performs temperature adjustment by heat exchange (heating or cooling) of the primary pure water with respect to the primary pure water. Examples of the heat exchanger 21 include a plate-type heat exchanger, but the specific structure is not particularly limited.

The primary pure water whose temperature has been adjusted by the heat exchanger 21 is fed to the ultraviolet irradiation device 23. The ultraviolet irradiation device 23 irradiates the primary pure water with ultraviolet rays to decompose organic substances, kill live bacteria (sterilize), and the like in the primary pure water. As long as the ultraviolet irradiation device 23, for example, includes an ultraviolet lamp capable of radiating a wavelength around 185 nm or a wavelength around 254 nm, it is possible to reliably decompose the organic substances in the primary pure water and perform sterilization. The ultraviolet lamp to be used is not particularly limited, but a low-pressure mercury lamp is preferable from the viewpoint of ease of handling. Examples of the ultraviolet irradiation device include a circulation type and an immersion type, and the circulation type is preferable from the viewpoint of process efficiency.

The membrane degassing device 25 is a device that removes a gas, particularly dissolved oxygen, in primary pure water using a gas separation membrane which a moisture does not permeate but a gas permeate. The primary pure water processed by the membrane degassing device 25 has a low concentration of dissolved oxygen.

The primary pure water Whose dissolved oxygen concentration has been reduced by the membrane degassing device 25 is fed to the non-regenerative ion exchange device 27.

The non-regenerative ion exchange device 27 is a device that removes impurity ions such as organic acids generated in the ultraviolet irradiation device 23. For example, it is a structure in which a cylindrical airtight container is filled with a non-regenerative ion exchange resin.

The primary pure water from which impurity ions have been removed by the non-regenerative ion exchange device 27 is fed to the ultrafiltration membrane (UF) 28.

The ultrafiltration membrane (UF) 28 is a device that removes fine particles to produce ultrapure water, and is disposed at an end of the secondary pure water device 20.

In the secondary pure water device 20, for example, an oxidant removing device including a catalyst resin carrying Pt or Pd metal or a reducing resin carrying a sulfite group, a hydrogen sulfite group, a nitrite group, or the like can be installed.

The secondary pure water device 20 is connected to a place for use (use point) 30 via a second delivery pipe 29. The ultrapure water obtained by the secondary pure water device 20 is delivered to the use point 30 through the second delivery pipe 29.

At the use point 30, the supplied ultrapure water is used. The use point 30 is installed at substantially the same height as the secondary pure water device 20 or at a position higher than the secondary pure water device 20 in the vertical direction. Among the supplied ultrapure water, unused ultrapure water is circulated and recovered to the pure water tank 16 through a return pipe 32 described later, and stored in the pure water tank 16 together with the primary pure water.

The pure water tank 16 and the use point 30 are connected by the return pipe 32. A first pressure regulating valve 40 is provided at a first position H1 of the return pipe 32. The first position H1 is provided at a position higher than the intermediate position of the height difference of the return pipe 32 in the vertical direction, and is preferably set at a position equal to or higher than the installation height of the secondary pure water device 20 and equal to or lower than the installation height of the use point 30.

The return pipe 32 is configured by connecting, welding, melting, or bonding a plurality of pipes with a connection member such as a flange in order to form a relatively long flow path.

The material of the pipe is not particularly limited, but examples of the material of the pipe can include polyvinylidene fluoride (PVDF), polyvinyl chloride (PVC), stainless steel such as SUS 304 or SUS 316. In a case in which the liquid is ultrapure water, PVDF is preferably used.

In a case in which the difference in height between the highest position of the use point 30 and the water surface H0 of the pure water tank 16 is 5 m or more, there is a possibility that the atmosphere is mixed into the return pipe 32 or the return pipe 32 is deformed in a case in which the number of pressure regulating valves is one. In a case in which the difference in height is 10 m or more, and further 30 m or more, this possibility increases.

The first pressure detector 41 is provided downstream of the use point 30 of the return pipe 32 and upstream of the first pressure regulating valve 40. The first pressure detector 41 measures the pressure at the outlet of the use point 30. The pressure in the return pipe 32 measured by the first pressure detector 41 is defined as a first pressure PR1, and a measured value signal thereof is defined as a first pressure signal PRS1. The first pressure signal PRS1 is delivered to a pressure control unit 50 described later.

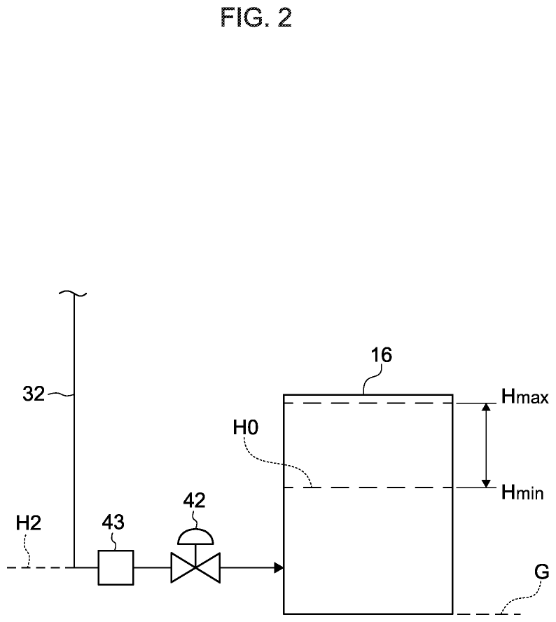

A second pressure regulating valve 42 is provided at a second position H2 of the return pipe 32. The second position H2 is disposed at a height equal to or lower than the water level H0 of the pure water tank 16 in the vertical direction. As illustrated in FIG. 2, the water level of the pure water tank 16 from the ground G varies between Hmin and Hmax. In the present embodiment, the second position H2 is disposed at a position lower than the water level Hmin.

A second pressure detector 43 is provided downstream of the first position H1 of the return pipe 32 and upstream of the second pressure regulating valve 42. The second pressure detector 43 measures the pressure in the return pipe 32. The pressure in the return pipe 32 measured by the second pressure detector 43 is defined as a second pressure PR2, and a measured value signal thereof is defined as a second pressure signal PRS2. The second pressure signal PRS2 is delivered to the pressure control unit 50 described later. The pressure in the return pipe 32 downstream of the second pressure regulating valve 42 is defined as a third pressure PR3.

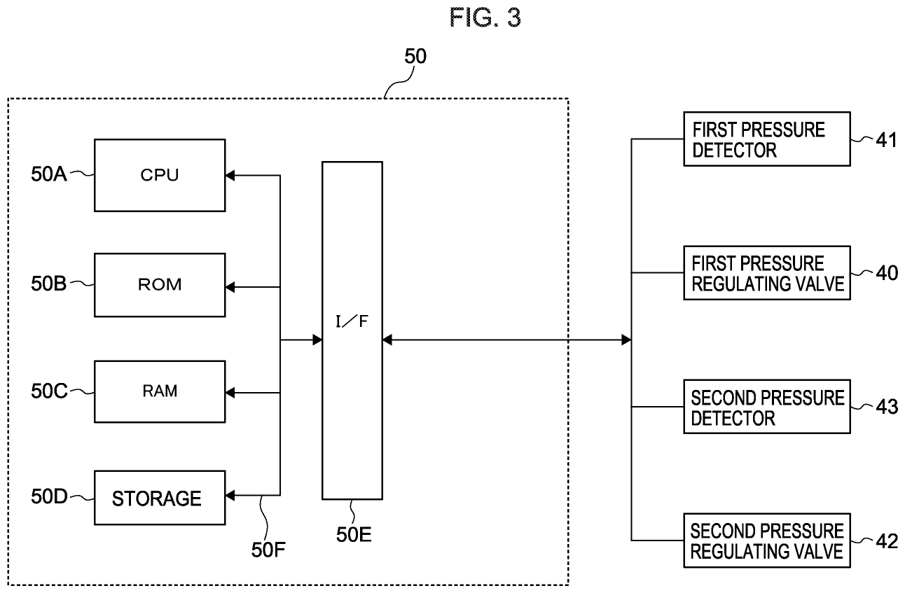

The ultrapure water supply system 10 includes the pressure control unit 50 illustrated in FIG. 3. The pressure control unit 50 includes a CPU 50A, a ROM 50B, a RAM 50C, a storage 50D, an I/F 50E, and a bus 50F such as a data bus or a control bus that connects these components. The storage 50D stores an upstream pressure PRA, and an intermediate pressure PRB. The upstream pressure PRA is set to a value of the first pressure PR1 obtained to maintain the pressure at the use point 30 at a desired pressure. The intermediate pressure PRB is set to a value equal to or lower than the upstream pressure PRA to such an extent that the downstream side of the return pipe 32 with respect to the first pressure regulating valve 40 does not become a negative pressure.

The first pressure detector 41, the first pressure regulating valve 40, the second pressure detector 43, and the second pressure regulating valve 42 are connected to the I/F 50E. The first pressure signal PRS1 and the second pressure signal PRS2 are input from the first pressure detector 41 and the second pressure detector 43 to the pressure control unit 50. The pressure control unit 50 controls the first pressure regulating valve 40 and the second pressure regulating valve 42 based on the input first pressure signal PRS1 and second pressure signal PRS2.

Next, pressure regulation of the return pipe 32 in the ultrapure water supply system 10 of the present embodiment will be described.

The pressure control unit 50 outputs a signal for adjusting the opening degree of the first pressure regulating valve 40 to the first pressure regulating valve 40 based on the input first pressure signal PRS1 so that the first pressure PR1 is the upstream pressure PRA. That is, the opening degree of the first pressure regulating valve 40 is feedback-controlled so that the first pressure PR1 is the upstream pressure PRA.

In addition, the pressure control unit 50 outputs a signal for adjusting the opening degree of the second pressure regulating valve 42 to the second pressure regulating valve 42 based on the input second pressure signal PRS2 so that the second pressure PR2 is the intermediate pressure PRB. That is, the opening degree of the second pressure regulating valve 42 is feedback-controlled so that the second pressure PR2 is the intermediate pressure PRB.

In this manner, the pressure of the return pipe 32 is adjusted so that the first pressure PR1 is the upstream pressure PRA by the first pressure regulating valve 40 and the second pressure PR2 is the intermediate pressure PRB by the second pressure regulating valve 42, whereby the pressure difference due to the height difference of the pipe can be controlled in a stepwise manner. That is, it is possible to reduce the pressure difference between the first pressure PR1 and the second pressure PR2 and the pressure difference between the second pressure PR2 and the third pressure PR3 as compared with a case in which the number of pressure regulating valves is one. Therefore, it is possible to suppress deformation of the return pipe 32 caused by the action of the negative pressure in the return pipe 32 downstream of the second position H2 and inflow of foreign matter from the connection portion into the return pipe 32.

In addition, since the second position H2 is set to a low height equal to or lower than the water level of the pure water tank 16, the third pressure PR3 is equal to the pressure at the water level Therefore, it is possible to suppress deformation of the return pipe 32 caused by the action of the negative pressure in the return pipe 32 downstream of the second position H2 and inflow of the atmosphere into the return pipe 32 from the connection portion.

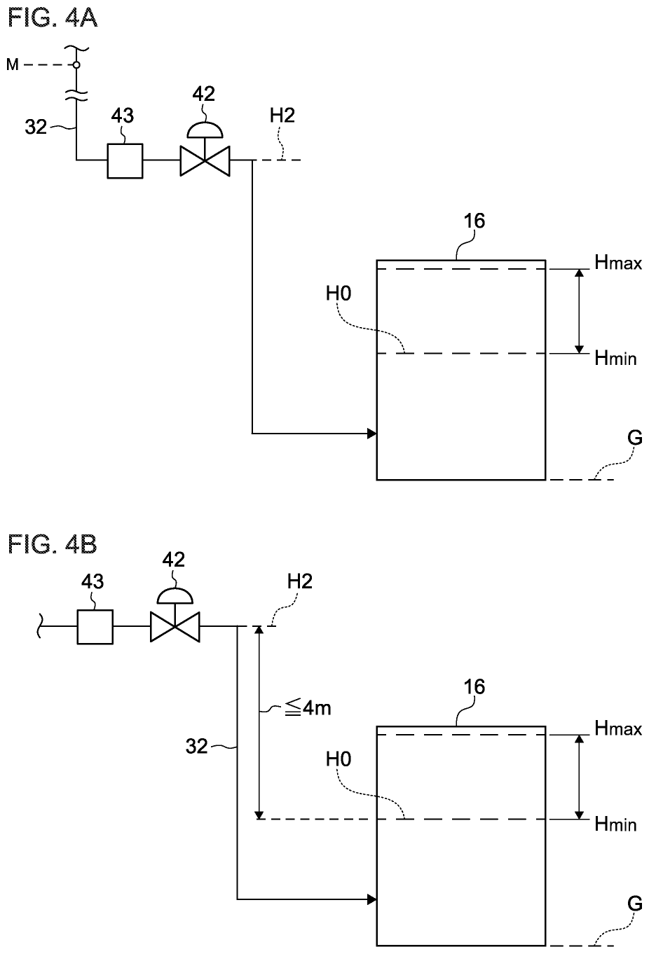

In the embodiment, the second position H2 is set to a low height equal to or lower than the water level H0 of the pure water tank 16, but the second position H2 is not necessarily equal to or lower than the water level H0, and the second position H2 may be provided at a position where the third pressure PR3 is positive at all times. As shown in FIG. 4A, the second position H2 may be provided vertically below (lower position) the intermediate position M of the height difference of the return pipe 32, or as shown in FIG. 4B, the second position H2 may be provided at a position where the height difference DH with the water level H0 of the pure water tank 16 is within 4 m. Even in these cases, the pressure difference in the pipe caused by the height difference of the return pipe 32 downstream of the second position H2 is reduced, and the deformation of the pipe caused by the negative pressure acting on the return pipe 32 and the inflow of the atmosphere into the return pipe 32 can be suppressed. In a case in which the second position H2 is set to a low height equal to or lower than the water level H0 of the pure water tank 16, the third pressure PR3 is more preferably equal to the pressure in the pure water tank 16.

### Second Embodiment

Next, a second embodiment of the invention will be described. In the second embodiment, the portions as same those of the first embodiment are denoted by the same reference numerals, and a detailed description thereof will be omitted.

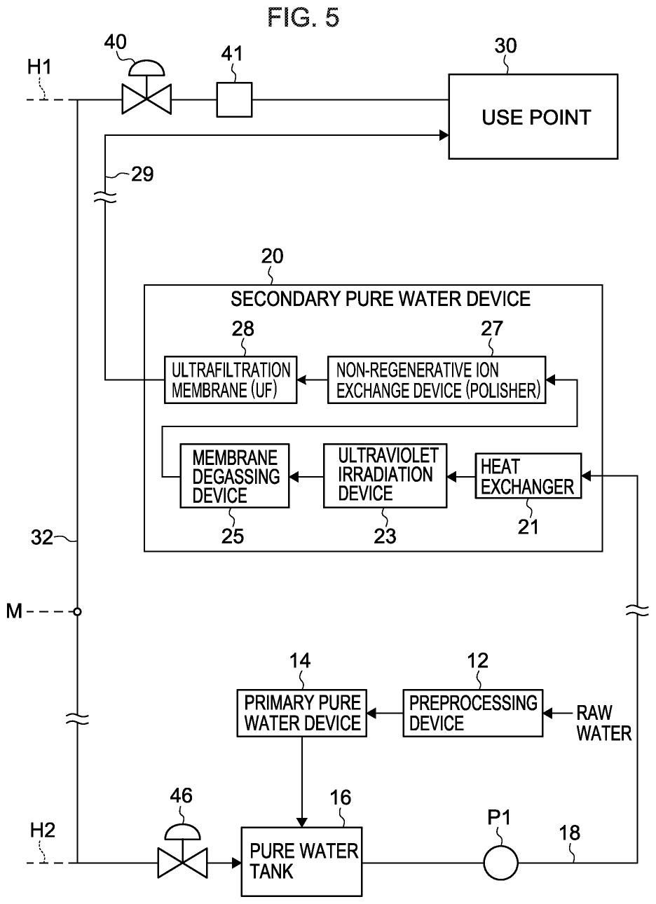

As shown in FIG. 5, in the embodiment, a mechanical pressure regulating valve 46 is included instead of the second pressure regulating valve 42. Other configurations are the same as those of the first embodiment.

The mechanical pressure regulating valve 46 adjusts the differential pressure between the second pressure PR2 and the atmospheric pressure to a predetermined differential pressure value PRC. Examples of the mechanical pressure regulating valve 46 can include a self-acting pressure regulating valve of a spring type or the like, or a non-self-acting pressure regulating valve of an electric type, an air type.

In this manner, by adjusting the differential pressure between the second pressure PR2 and the atmospheric pressure to be the predetermined differential pressure value PRC using the mechanical pressure regulating valve 46, it is possible to control the pressure difference due to the height difference of the return pipe 32 in a stepwise manner as in the first embodiment. That is, it is possible to reduce the pressure difference between the first pressure PR1 and the second pressure PR2 and the pressure difference between the second pressure PR2 and the third pressure PR3 as compared with a case in which the number of pressure regulating valves is one. Therefore, the pressure of the use point 30 for which a predetermined pressure is required can be easily adjusted.

Also in the embodiment, the second position H2 may be set to a low height equal to or lower than the water level of the pure water tank 16, or may be provided at a position where the third pressure PR3 is positive at all times. Further, the second position H2 may be provided vertically below (lower position) the intermediate position M of the height difference of the return pipe 32, or the second position H2 may be provided at a position Where the height difference DH with the water level H0 of the pure water tank 16 is within 9 m. Even in these cases, the pressure difference in the pipe caused by the height difference of the return pipe 32 downstream of the second position H2 is reduced, and the deformation of the pipe caused by the negative pressure acting on the return pipe 32 and the inflow of foreign matter into the return pipe 32 can be suppressed.

In the first and second embodiments described above, an example of collecting and supplying ultrapure water is described. The invention may be used in a system for collecting and supplying another liquid. For example, it can also be used for functional water in which a specific substance such as hydrogen, ozone, or carbonic acid is dissolved, degassed water obtained by subjecting raw water or the like to a degassing process, heated pure water or heated ultrapure water produced by heating pure water or ultrapure, water, normal pure water, purified water in pharmaceutical and pharmaceutical production, or water for injection.

In a case in Which the liquid has a high temperature of, for example, 40° C. or higher, the packing of the connection portion such as the flange is soft, so that a problem is likely to occur. Therefore, the use of the invention is an effective countermeasure.

In addition, in the case of producing pure water or ultrapure water in a semiconductor or liquid crystal factory, since the flow rate is large (for example, 50 m³/h or more and 100 m³/h or more), the area of the connection portion such as a flange is large, and the problem that has been raised in the present application is likely to occur. Therefore, the use of the invention is an effective countermeasure.

### Examples

In order to verify the effect of the ultrapure water supply system 10 of the embodiment, the dissolved oxygen concentration (DO) in the ultrapure water in the return pipe 32 was measured in Examples 1 to 3 and Comparative Example under the following conditions. In Comparative Example, the second pressure regulating valve 42 is not provided,
Return pipe 32 height difference of 40 m (the use point 30 to the water level H0 of the pure water tank 16)
No height difference between the first pressure regulating valve 40 and the use point 30
No height difference between the second pressure regulating valve 42 and the water level H0 (Example 1), a height difference of 3 in (Example 2), and a height difference of 5 m (Example 3).
In the first pressure regulating valve 40, the upstream pressure PRA is set to 0.2942 MPa to adjust the first pressure PR1.
In the second pressure regulating valve 42, the upstream pressure PRA is set to 0.2942 MPa to adjust the first pressure PR1.
Flow rate of 100 m³/h
Water temperature of 25° C.
Measuring instrument: MOCA-3600, manufactured by Orbisphere company.

TABLE 1

| | Dissolved oxygen con- | |
|---|---|---|
| | centration (DO) (First | Dissolved oxygen con- |
| | pressure regulating | centration (DO) (Before |
| | valve upstream side) | pure water tank) |
| Example 1 | 0.4 μg/L | 0.4 μg/L |
| Example 2 | 0.4 μg/L | 0.7 μg/L |
| Example 3 | 0.4 μg/L | 1.0 μg/L |
| Comparative | 0.6 μg/L | 4 to 6 mg/L |
| Example | | |

In Comparative Example, the dissolved oxygen concentration before the pure water tank 16 was higher than that in each of Examples 1 to 3, and values nearly 10,000 times as high as those in Examples were confirmed. This is considered to be because the pressure difference increases at the downstream side relative to the first pressure regulating valve 40, the return pipe 32 is strained, a minute gap is generated at a connection portion such as a flange portion, the outside air is mixed from the gap, and the air is mixed into the ultrapure water.

In the comparative example, the dissolved oxygen concentration is also higher at an upstream side relative to the first pressure regulating valve 40, compared with that in Examples 1 to 3. This is considered to be because since the dissolved oxygen concentration of the primary, pure water in the pure water tank 16 is high, oxygen remains slightly despite oxygen removal in the membrane degassing device 25 of the secondary pure water device 20.

From the above, it was confirmed that the amount of dissolved oxygen in Examples 1 to 3 was able be maintained lower than that in Comparative Example.

What is claimed is:

1. A liquid recovery system comprising:
a tank that is provided vertically below a use point, at Which a liquid is used, and that stores the liquid;
a pipe that connects the use point and the tank and through which the liquid is returned from the use point to the tank;
a first pressure regulating unit that is provided at a first position of the pipe, and that regulates a first pressure upstream of the first position; and
a second pressure regulating unit that is provided at a second position downstream of the first position of the pipe and vertically below the first position, and that regulates a second pressure downstream of the first position and upstream of the second position.

2. The liquid recovery system according to claim 1, wherein:
the first position is above a central portion of the pipe in a vertical direction, and
the second position is below the central portion.

3. The liquid recovery system according to claim 1, wherein the second position is at a height equal to or lower than a water level of the tank in a vertical direction.

4. The liquid recovery system according to claim 1, wherein
the second position is at a height at which a downstream pressure is positive and constant.

5. The liquid recovery system according to claim 1, wherein the first pressure regulating unit regulates the first pressure so that the first pressure is a predetermined upstream pressure.

6. The liquid recovery system according to claim 1, wherein the second pressure regulating unit regulates the second pressure so that the second pressure is a predetermined intermediate pressure.

7. The liquid recovery system according to claim 1, wherein the second pressure regulating unit regulates the second pressure so that a difference between the second pressure and an atmospheric pressure is a predetermined value.

8. A liquid supply system comprising:
the liquid recovery system according to claim 1;
a processing unit that processes the liquid stored in the tank; and
a use supply path that supplies the liquid processed by the processing ur e point.

9. The liquid supply system according to claim 8, further comprising:
a primary processing unit that performs primary processing of raw water; and
a primary supply path through which a primary processed liquid processed by be primary processing unit is supplied to the tank.

10. A pressure regulating method of connecting a use point, at which a liquid is used, and a tank that is provided vertically below the use point and that stores the liquid, and regulating a pressure of a pipe through Which the liquid is returned from the use point to the tank, the pressure regulating method comprising:
adjusting a first pressure upstream of a first position of the pipe to a predetermined upstream pressure; and
adjusting a second pressure upstream of a second position, the second position downstream of the first position of the pipe and vertically below the first position, to a predetermined intermediate pressure.
